(19) United States
(12) Patent Application Publication
(10) Pub. No.: US 2019/0093451 A1
(43) Pub. Date: Mar. 28, 2019

(54) REDUCING WATER PERMEABILITY IN SUBTERRANEAN FORMATIONS USING PETROLEUM PRODUCTS

(71) Applicant: Saudi Arabian Oil Company, Dhahran (SA)

(72) Inventors: Ayman Raja Al-Nakhli, Damman (SA); Ahmad Noor Al-deen Hassan Rizq, Dhahran (SA)

(21) Appl. No.: 15/717,259

(22) Filed: Sep. 27, 2017

(51) Int. Cl. E21B 33/138; E21B 36/00; C09K 8/44; C04B 26/26

(52) U.S. Cl. CPC E21B 33/138; C04B 26/26; C09K 8/44; E21B 36/008

(57) ABSTRACT

Reducing water permeability in a subterranean formation includes decreasing a viscosity of a petroleum product including at least one of asphaltenes and tar to yield a treatment material, providing the treatment material to an oil-producing well in a subterranean formation, solidifying the treatment material in the subterranean formation, and initiating production from the oil-producing well.

### TECHNICAL FIELD

This disclosure relates to reducing water permeability in subterranean formations using petroleum products to control excessive water production.

### BACKGROUND

Naturally fractured carbonate reservoirs with super-K zones can produce substantial volumes of both oil and water. “Super-K zones” generally refer to narrow layers of exceptional flow capacity that produce over 500 barrels per day per foot of thickness (BLPD/ft). Super-K zones can be a source of excessive water production. As used herein, “excessive water production” is defined as the undesired water produced from hydrocarbon wells either on initial completion or after they have been producing for some time. Excessive water production may be due at least in part to fractures (both natural and hydraulically induced), channels, faults and joints, and channeling behind pipes. FIG. 1 depicts reservoir 100, injector well 102, and producer well 104. Water 106 reaches producer well 104 through super-K zone 108, and is produced with oil 110 through the producer well. Excessive water production from hydrocarbon-producing wells reduces hydrocarbon production rates, thereby decreasing the profitability of the wells. This unwanted fluid production may occur over the entire life cycle of a well, typically requiring extra expenditures to construct and operate water handling facilities, and leading to corrosion, scale formation, fines migration, sandface failure, and hydrostatic loading.

### SUMMARY

This disclosure describes compositions, systems, and methods for reducing water permeability in a subterranean formation with petroleum products to control excessive water production.

In a general aspect, reducing water permeability in a subterranean formation includes decreasing a viscosity of a petroleum product to yield a treatment material, providing the treatment material to an oil-producing well in a subterranean formation, solidifying the treatment material in the subterranean formation, and initiating production from the oil-producing well.

Implementations of the first general aspect may include one or more of the following features.

The petroleum product typically includes at least one of asphaltenes and tar.

In some embodiments, decreasing the viscosity of the petroleum product includes combining the petroleum product with a solvent. The solvent may include at least one of pentane, cyclohexane, methylcyclohexane, benzene, xylene, toluene, diesel, isopropyl benzene, decalin, tetralin, methylnaphthalene, acetone, and chloroform. In some examples, the solvent includes, consists essentially of, or consists of xylene. In some examples, the solvent includes, consists essentially of, or consists of xylene, acetone, and chloroform. In some examples, the solvent includes, consists essentially of, or consists of diesel.

In some embodiments, decreasing the viscosity of the petroleum product includes heating the petroleum product. Heating the petroleum product may include heating the petroleum product with heat released from an exothermic chemical reaction. In one example, a suitable exothermic chemical reaction includes:

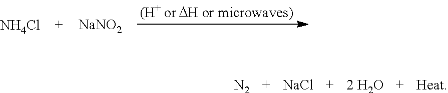

Heating the petroleum product with heat released from an exothermic chemical reaction may include combining reactants of the exothermic chemical reaction with the petroleum product. In one example, heating the petroleum product with heat released from the exothermic chemical reaction includes combining ammonium chloride and sodium nitrite with the petroleum product.

In some embodiments, a viscosity of the petroleum product is between 5,500 cP and 6,000 cP at 20° C. and between 700 cP and 800 cP at 100° C. A viscosity of the treatment material is typically between 1,000 cP and 10,000 cP at 24° C.

In some embodiments, providing the treatment material to the subterranean formation includes injecting the treatment material into the subterranean formation. In certain embodiments, providing the treatment material to the subterranean formation includes identifying a super-K zone, and providing the treatment material to the super-K zone.

In some embodiments, the subterranean formation includes carbonate rock, and solidifying the treatment material in the subterranean formation includes contacting the carbonate rock with the treatment material and increasing a viscosity of the treatment material. The carbonate rock typically defines pores and fractures, and solidifying the treatment material in the subterranean formation typically includes solidifying the treatment material in the pores and fractures. Solidifying the treatment material in the pores and fractures may include binding the treatment material to the carbonate rock, reducing water permeability of the carbonate rock, or a combination thereof.

Unlike conventional water shutoff chemicals, which can be damaging for both water and oil producing zones and can therefore require mechanical isolation and careful placement to prevent polymer from invading oil-bearing zones, compositions described herein are not damaging to oil-bearing zones and can be bullheaded without a need for mechanical isolation as the fluid is not damaging to oil bearing zones. Also, unlike conventional compositions and methods, compositions and methods described herein can be effectively applied to mixed wettability zones that produce both oil and water. While other polymer-based shutoff methods are typically designed for sandstone reservoirs and display instability or do not strongly adsorb to carbonate reservoirs, particularly under high fluid flow or high salinity, compositions and methods described herein can be advantageously applied to carbonate as well as sandstone reservoirs for water shutoff, significantly reducing water permeability and providing treatment stability.

While many commercially available water shutoff products require the rock matrix to be preferentially water wet to promote robust adsorption and attachment and prolonged adhesion, compositions and methods described herein can typically be applied to oil wet surfaces without a preconditioning treatment. Other advantages of compositions and methods described herein include the use of readily available and cost-effective raw materials, and ease of treatment and removal from a formation without damage residual.

The details of one or more implementations of the subject matter described in this specification are set forth in the accompanying drawings and the following description. Other features, aspects, and advantages of the subject matter will become apparent from the description, the drawings, and the claims.

### BRIEF DESCRIPTION OF THE DRAWINGS

FIG. 1 depicts water breakthrough in a reservoir with a super-K zone.

FIG. 2 is a flow chart showing an exemplary process for reducing water permeability in a subterranean formation using a petroleum product.

FIG. 3A depicts an oil producing zone and a water producing zone in a subterranean formation prior to treatment as described herein to reduce water permeability.

FIG. 3B depicts an oil producing zone and a water producing zone in a subterranean formation after treatment as described herein to reduce water permeability.

FIG. 4 shows a decrease in brine permeability of carbonate rock after treatment with oil containing asphaltenes.

FIG. 5 shows a temperature profile of an exothermic reaction.

FIG. 6 shows a downhole temperature profile of an exothermic reaction in an oil well.

FIG. 7 shows reduction in the viscosity of an asphaltenes sample following initiation of an exothermic reaction with reactants combined with the asphaltenes sample.

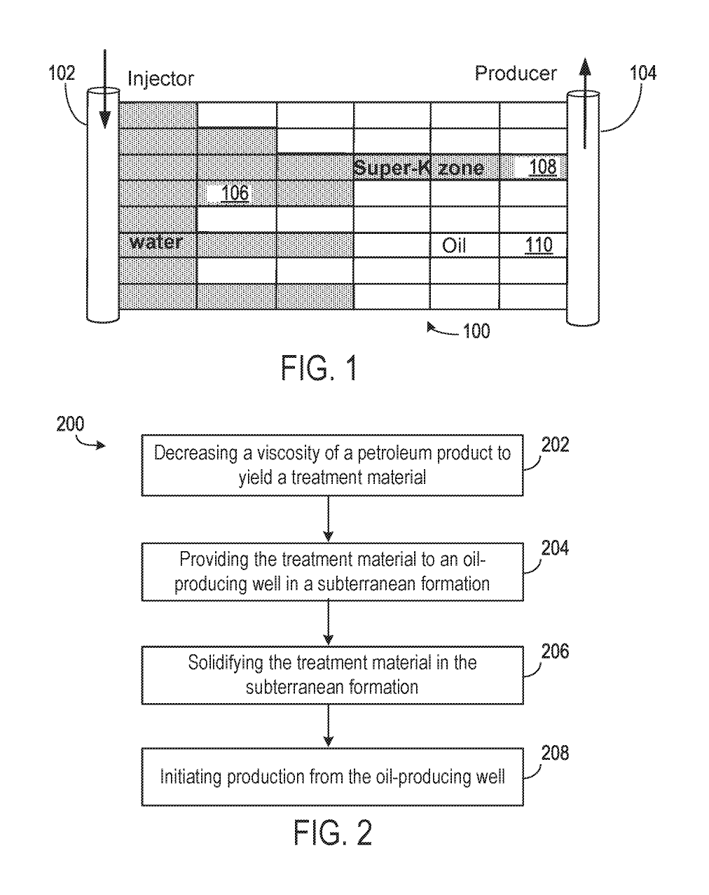

### DETAILED DESCRIPTION

Referring to FIG. 2, process 200 is an exemplary process for water shutoff in a subterranean formation using a petroleum product to control excessive water production. The petroleum product includes at least one of asphaltenes and tar. Asphaltenes are high-molecular-weight components of petroleum fluids. Asphaltenes and tar are solid or semi-solid at ambient temperature in a subterranean formation. A viscosity of asphaltenes at 20° C. is at least 5800 cP, and a viscosity of tar at 20° C. can range from 5,000 to 100,000 cP. The American Petroleum Institute (API) gravity of asphaltenes can range from 11 to 22, and the API gravity of tar can range from 7 to 14.

In 202, a viscosity of the petroleum product is decreased to yield a treatment material. As described herein, “petroleum product” refers to asphaltenes, tar, or a combination thereof. In some embodiments, decreasing the viscosity of the petroleum product includes at least one of heating the petroleum product and combining the petroleum product with an organic solvent. Examples of suitable organic solvents include xylene, benzene, diesel, cyclohexane, toluene, methylcyclohexane, isopropyl benzene, decalin, tetralin, methylnaphthalene, acetone, and chloroform. In some embodiments, the solvent includes xylene. In certain embodiments, the solvent consists of or consists essentially of xylene. In certain embodiments, the solvent consists of or consists essentially of diesel. In some embodiments, the solvent includes xylene, acetone, and chloroform. In certain embodiments, the solvent consists of or consists essentially of xylene, acetone, and chloroform. The volume ratio of solvent to the petroleum product is typically in a range of 5 wt % to 60 wt %. In one example, the volume ratio of the solvent to the petroleum product is about 1:10. A viscosity of the petroleum product is typically between 5,500 cP and 6,000 cP at 20° C. and between 700 cP and 800 cP at 100° C. A viscosity of the treatment material is typically in a range of about 1,000 cP to about 10,000 cP at 24° C.

Heating the petroleum product may include using any source of thermal energy to increase a temperature of the petroleum product. The petroleum product may be heated to a temperature in a range of about 90° C. to about 210° C. to decrease its viscosity. In some embodiments, a viscosity of the heated petroleum product is between 10 cP and 500 cP.

In one embodiment, heating the petroleum product includes providing heat released from an exothermic chemical reaction to the petroleum product. In certain embodiments, the exothermic chemical reaction includes one or more redox reactants that exothermically react to produce heat and increase pressure in a closed system. Suitable redox reactants include urea, sodium hypochlorite, ammonium containing compounds, and nitrite containing compounds. In some embodiments, the exothermic chemical reaction includes ammonium containing compounds, such as ammonium chloride, ammonium bromide, ammonium nitrate, ammonium sulfate, ammonium carbonate, and ammonium hydroxide. In some embodiments, the exothermic chemical reaction includes nitrite containing compounds, such as sodium nitrite and potassium nitrite. In some embodiments, reactants include urea and sodium hypochlorite, urea and sodium nitrite, ammonium hydroxide and sodium hypochlorite, ammonium chloride and sodium nitrite, and sodium nitrite and ammonium nitrate.

In some embodiments, the exothermic reaction includes at least one ammonium containing compound and at least one nitrite containing compound. One example of a suitable combination of an ammonium containing compound and a nitrite containing compound is ammonium chloride (NH₄Cl) and sodium nitrite (NaNO₂), which react as shown below:

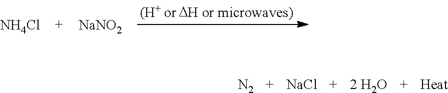

In some embodiments, reactants for an exothermic reaction are combined with the petroleum product to yield the treatment material. In one example, ammonium chloride and sodium nitrite are combined with the petroleum product to yield the treatment material. In some embodiments, reactants for an exothermic reaction are combined with the petroleum product and a solvent described herein to yield the treatment material. In some embodiments, exothermic reactants are combined with the solvent. A concentration of the exothermic reactants in the solvent can be in a range of 1 Molar (1M) to 6 Molar (6M). The reactants may be present a range of molar ratios of 2:1 to 1:2. In one example, the reactants are present in approximately equimolar amounts. As the exothermic reaction proceeds, a temperature of the petroleum product increases and its viscosity decreases. A suitable weight ratio of petroleum product to solvent is in the range of 5:95 to 75:25.

Table 1 shows viscosity reduction for tar (API<11) (including 11 wt % of asphaltene) when mixed with various amounts of toluene and diesel. The samples in Table 1 were charged in a temperature-controlled high pressure high temperature (HPHT) cell to avoid evaporation of light-end hydrocarbons during heating. The sample was allowed to equilibrate at 70° C. for 10 to 15 minutes, and dynamic viscosity was measured with an Anton Paar rheometer at a shear rate of 200 second⁻¹ (s⁻¹).

TABLE 1
Viscosity reduction of tar with toluene and diesel

| Tar (wt %), | Toluene | Diesel | Viscosity (CP) |
|---|---|---|---|
| API < 11 | (wt %) | (wt %) | (70° C.) |
| 100 | 0 | 0 | 2330 |
| 75 | 25 | 0 | 26 |
| 50 | 50 | 0 | 2.8 |
| 75 | 0 | 25 | 376 |
| 50 | 0 | 50 | 36.3 |
| 75 | 12.5 | 12.5 | 63.8 |
| 50 | 25 | 25 | 9.8 |

In 204, the treatment material is provided to a subterranean formation. Providing the treatment material to the subterranean formation typically includes injecting the treatment material into the subterranean formation. In some embodiments, process 200 includes identifying carbonate rock in a reservoir and providing the treatment material to the carbonate rock, thereby contacting the carbonate rock with the treatment material. In some embodiments, process 200 includes identifying a super-K zone in a reservoir and providing the treatment material to the super-K zone, thereby contacting carbonate rock in the super-K zone with the treatment material. Carbonate rock typically includes pores and fractures, such that contacting carbonate rock with the treatment material includes filling or at least partially filling the pores and fractures with the treatment material.

In 206, the treatment material is solidified in the subterranean formation. Solidifying the treatment material in the subterranean formation includes increasing a viscosity of the treatment material. Increasing the viscosity of the treatment material includes lowering a temperature of the treatment material, removing solvent from the treatment material, or a combination thereof, to bind the petroleum product to the subterranean formation. At an ambient temperature in the subterranean formation, the petroleum product is a solid or semi-solid. In one example, when the treatment material is heated to a temperature that exceeds the ambient temperature of the formation and is then provided to the formation, the treatment material solidifies in the subterranean formation as heat from the treatment material is transferred to the subterranean formation and the temperature of the treatment material decreases to the ambient temperature in the subterranean formation. In some embodiments, removing the solvent from the treatment material includes flooding of the solvent with brine. Solification of treatment material in a subterranean formation typically occurs about 3 hours to about 6 hours after the treatment material is provided to the subterranean formation.

When the subterranean formation includes carbonate rock, solidifying the treatment material in contact with the carbonate rock results in binding the petroleum product to the carbonate rock. Binding the petroleum product to the carbonate rock includes forming chemical or physical bonds between the petroleum product and carbonate rock. When the carbonate rock includes pores and fractures, the treatment material in contact with the carbonate rock solidifies in the pores and fractures, thereby blocking the flow of fluid through the pores and fractures, and reducing water permeability of the carbonate rock.

In 208, production is initiated from the oil-producing well. The solidified treatment material in the subterranean formation results in a reduction in water permeability of at least two-fold. In some embodiments, the solidified treatment material in the subterranean formation results in up to a ten-fold, twelve-fold, or fifteen-fold reduction in water permeability

In some embodiments, operations in process 200 may be combined or omitted. In certain embodiments, an order of operations in process 200 may be changed. In certain embodiments, additional operations may be combined with process 200, such as identifying a target super-K zone before decreasing a viscosity of the petroleum product.

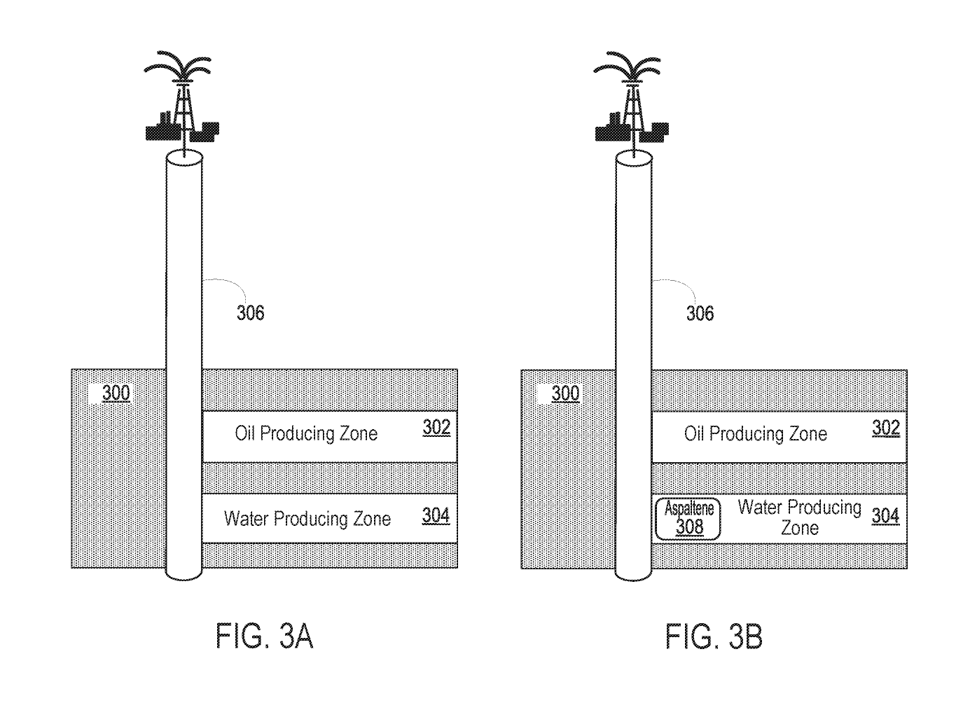

FIG. 3A depicts subterranean formation 300 with oil producing zone 302 and water producing zone 304 proximate wellbore 306 prior to treatment as described herein to reduce water permeability. FIG. 3B depicts subterranean formation 300 with oil producing zone 302 and water producing zone 304 proximate wellbore 306 after treatment as described herein to reduce water permeability. Treatment material 308 effectively blocks water in water producing zone 304 from reaching wellbore 306, thereby reducing water permeability.

### Examples

Coreflood testing was conducted to demonstrate water shutoff using asphaltenes. A carbonate core sample with 520 millidarcy (mD) of brine permeability was treated with a treatment material including 50 wt % tar (API<11) and 50 wt % diesel, having a viscosity of 36.3 cP at 158° F. An equimolar solution of 2 Molar (M) ammonium chloride and 2M sodium nitrite was injected into the carbonate core sample to provide in situ heat and pressure, allowing the treatment material to invade the core sample.

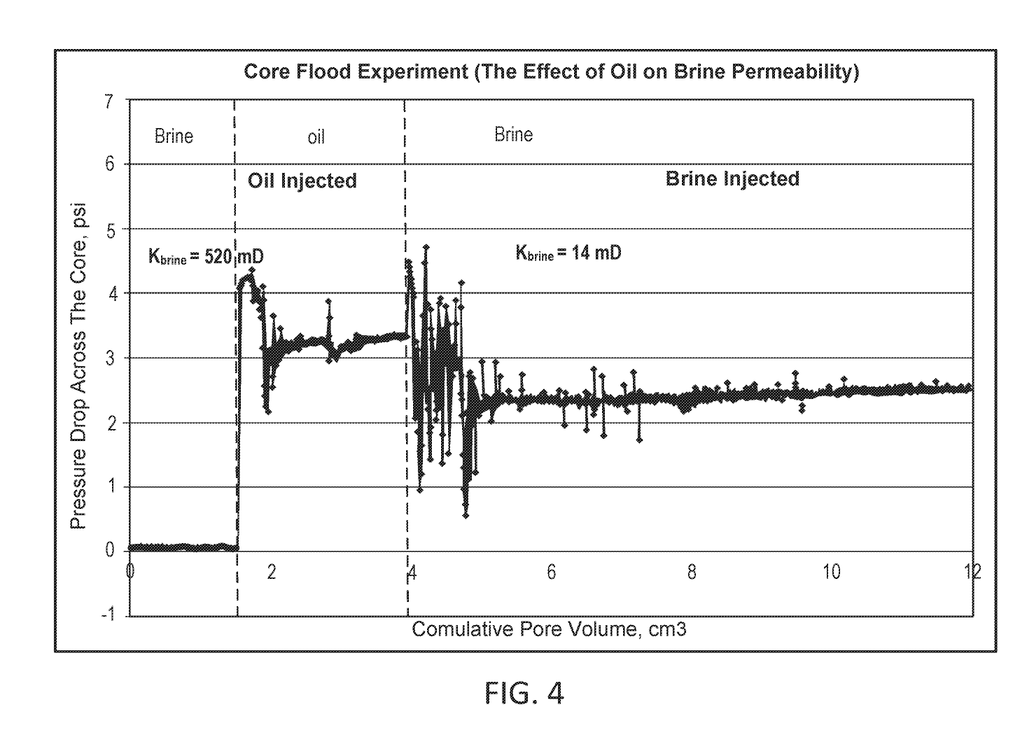

In the coreflood testing, one direction of the core sample was designated as production and one as injection. The core was marked accordingly such that an inadvertent change in direction was voided during loading. Two injection lines and one production line were coupled to the coreflood system. The core sample was loaded into the core holder, and appropriate confining stress and backpressure were applied. The oven temperature was adjusted to an ambient reservoir temperature of about 200° F. Brine was injected in the pre-designated production direction at a constant rate of 1 cc/min, and flowing was continued until a stable differential pressure across the core was obtained. Approximately 2 pore volumes of the treatment material was injected in the pre-designated injection direction at a constant rate of 1 cc/min. At the same time as the injection of the treatment material, approximately 2 pore volumes of a 1:1 volume mixture of ammonium chloride (2M) and sodium nitrite (2M) were injected in pre-designated injection direction through the second injection line at a constant rate of 1 cc/min. Formation brine was injected in the pre-designated production direction, and differential pressure was monitored. Brine permeability was measured after treatment of the core sample with the treatment material. FIG. 4 shows pressure drop across the core sample versus cumulative pore volume before, during, and after injection of the treatment material into the core sample. As seen in FIG. 4, the brine permeability was 14 mD after treatment, indicating a 97% reduction in water permeability.

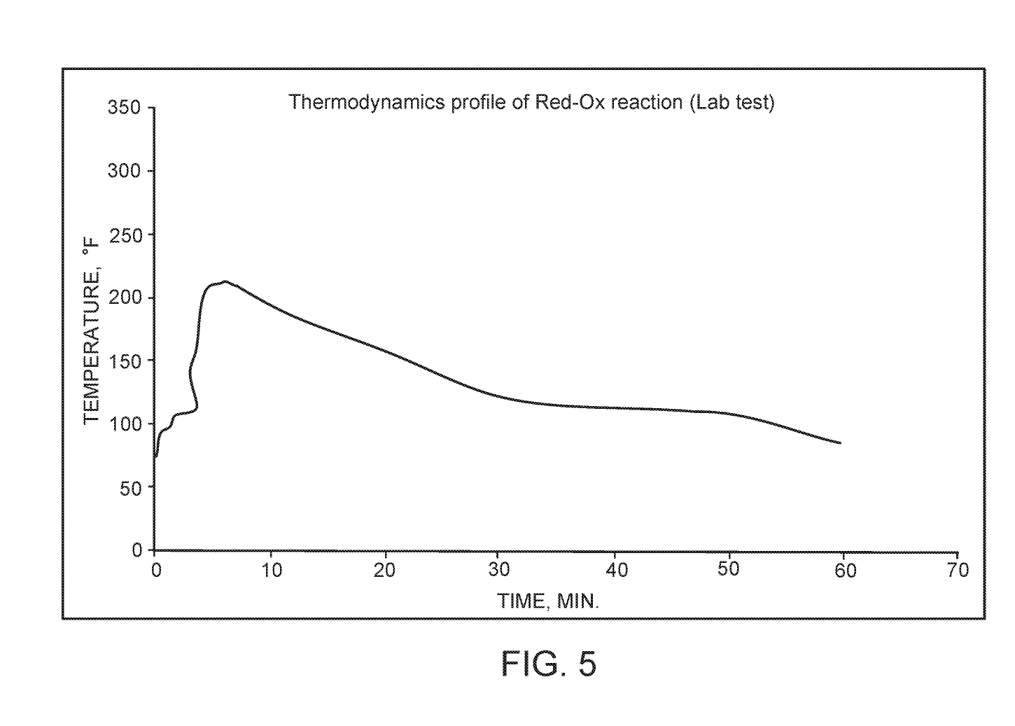

FIG. 5 shows a temperature profile of an exothermic reaction, in which 25 milliliters (mL) of 2M sodium nitrite and 25 mL of 2M ammonium chloride were combined in a 100 mL reactor and heated to 120° F. to initiate the exothermic reaction between sodium nitrite and ammonium chloride. About 5 minutes after initiation of the reaction, the temperature of the reactor increased to 220° F.

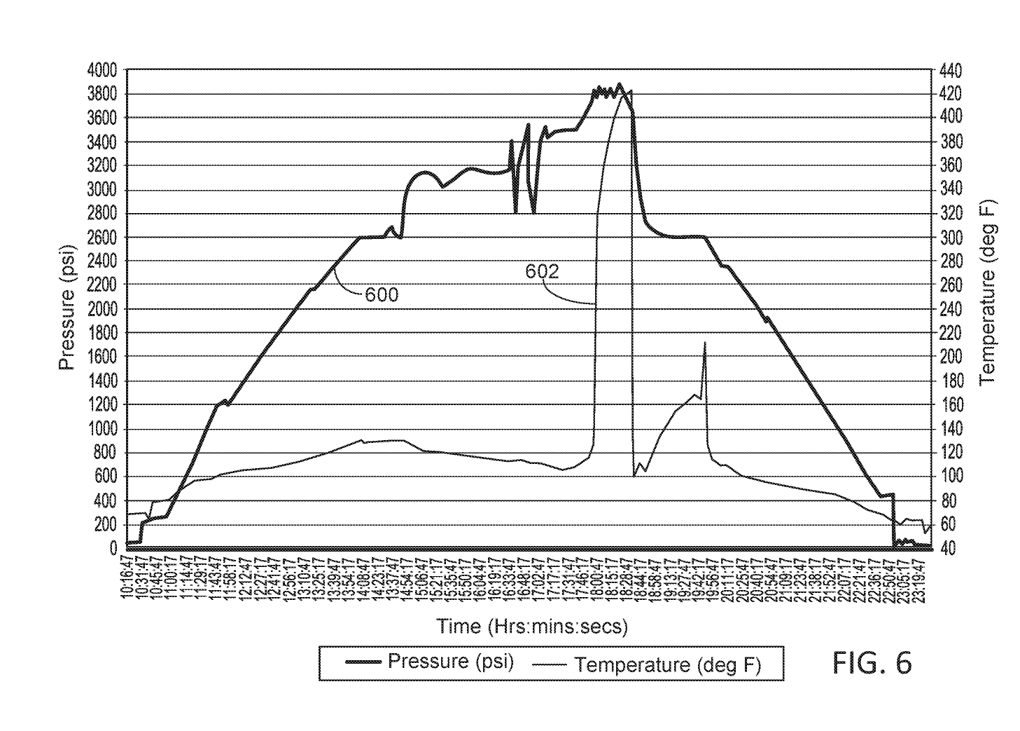

Plots 600 and 602 in FIG. 6 show downhole pressure and temperature profiles, respectively, of an exothermic reaction in an oil well. Coiled tubing was run to a target interval level in the well. The temperature and pressure at the target interval level were 130° F. and 2600 psi, respectively. After an equimolar solution (3M) of sodium nitrite and ammonium chloride was injected into the well, the temperature and pressure at the target interval level increased to 420° F. and 3800 psi, respectively.

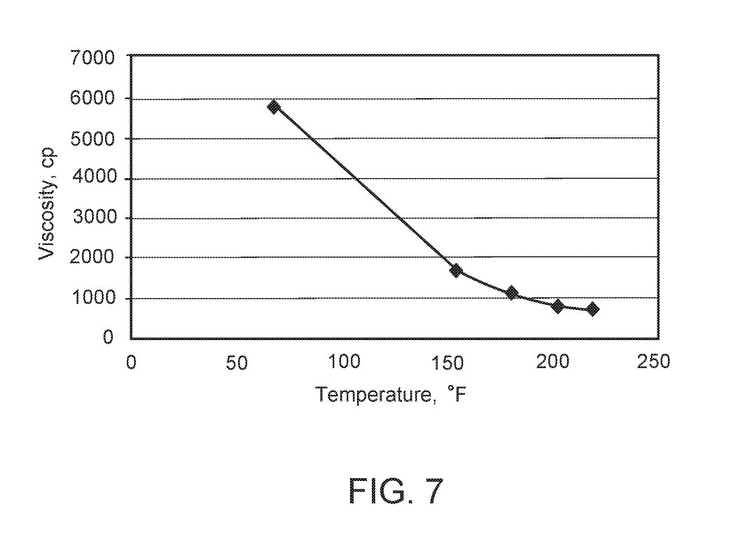

FIG. 7 shows reduction in the viscosity of an asphaltenes sample following initiation of an exothermic reaction with reactants combined with a sample including 11 wt % asphaltenes. The initial viscosity of the asphaltenes sample was 5800 cP at 68° F. The asphaltenes sample was combined in a 50:50 weight ratio with an equimolar solution of 2M ammonium chloride and 2M sodium nitrite in a viscometer. The exothermic reaction was initiated by heating the mixture to 120° F. The viscosity of the mixture was measured as the temperature increased due to the exothermic reaction. Table 2 lists temperature and viscosity of the asphaltenes sample.

TABLE 2
Temperature and viscosity for an asphaltenes
sample with exothermic reactants

| Temperature | Viscosity |
|---|---|
| (° F.) | (cP) |
| 68 | 5800 (initial) |
| 155 | 1700 |
| 182 | 1100 |
| 203 | 790 |
| 220 | 700 |

Thus, particular implementations of the subject matter have been described. Other implementations are within the scope of the claims.

What is claimed is:

1. A method of reducing water permeability in a subterranean formation, the method comprising:
decreasing a viscosity of a petroleum product to yield a treatment material;
providing the treatment material to an oil-producing well in a subterranean formation;
solidifying the treatment material in the subterranean formation; and
initiating production from the oil-producing well.

2. The method of claim 1, wherein the petroleum product comprises at least one of asphaltenes and tar.

3. The method claim 1, wherein decreasing the viscosity of the petroleum product comprises combining the petroleum product with a solvent.

4. The method of claim 3, wherein the solvent comprises at least one of pentane, cyclohexane, methylcyclohexane, benzene, xylene, toluene, isopropyl benzene, decalin, tetralin, methylnaphthalene, acetone, and chloroform.

5. The method of claim 4, wherein the solvent comprises xylene.

6. The method of claim 5, wherein the solvent consists essentially of xylene.

7. The method of claim 6, wherein the solvent consists of xylene.

8. The method of claim 5, wherein the solvent further comprises acetone and chloroform.

9. The method of claim 8, wherein the solvent consists essentially of xylene, acetone, and chloroform.

10. The method of claim 9, wherein the solvent consists of xylene, acetone, and chloroform.

11. The method of claim 1, wherein decreasing the viscosity of the petroleum product comprises heating the petroleum product.

12. The method of claim 11, wherein heating the petroleum product comprises heating the petroleum product with heat released from an exothermic chemical reaction.

13. The method of claim 12, wherein the exothermic chemical reaction comprises:

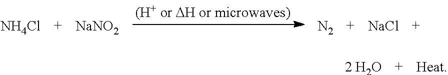

14. The method of claim 12, wherein heating the petroleum product with heat released from the exothermic chemical reaction comprises combining reactants of the exothermic chemical reaction with the petroleum product.

15. The method of claim 14, wherein heating the petroleum product with heat released from the exothermic chemical reaction comprises combining ammonium chloride and sodium nitrite with the petroleum product.

16. The method of claim 1, wherein a viscosity of the petroleum product is between 5,500 cP and 6,000 cP at 20° C. and between 700 cP and 800 cP at 100° C.

17. The method of claim 1, wherein a viscosity of the treatment material is between 1,000 cP and 10,000 cP at 24° C.

18. The method of claim 1, wherein providing the treatment material to the subterranean formation comprises injecting the treatment material into the subterranean formation.

19. The method of claim 1, wherein providing the treatment material to the subterranean formation comprises identifying a super-K zone, and providing the treatment material to the super-K zone.

20. The method of claim 1, wherein the subterranean formation comprises carbonate rock, and solidifying the treatment material in the subterranean formation comprises contacting the carbonate rock with the treatment material and increasing a viscosity of the treatment material.

21. The method of claim 20, wherein the carbonate rock defines pores and fractures, and solidifying the treatment material in the subterranean formation comprises solidifying the treatment material in the pores and fractures.

22. The method of claim 21, wherein solidifying the treatment material in the pores and fractures comprises binding the treatment material to the carbonate rock.

23. The method of claim 22, wherein solidifying the treatment material comprises reducing water permeability of the carbonate rock.
